(19) United States
(12) Patent Application Publication
(10) Pub. No.: US 2013/0059068 A1
(43) Pub. Date: Mar. 7, 2013

(54) METHOD OF MANUFACTURING EYEGLASS LENS

(71) Applicant: Eiichi YAJIMA, Shinjuku-ku (JP)

(72) Inventor: Eiichi YAJIMA, Shinjuku-ku (JP)

(73) Assignee: HOYA CORPORATION, Tokyo (JP)

(21) Appl. No.: 13/482,160

(22) Filed: May 29, 2012

(30) Foreign Application Priority Data
May 30, 2011 (JP) 2011-120632
May 28, 2012 (JP) 2012-120410

(51) Int. Cl. B05D 3/12

(52) U.S. Cl. 427/164

(57) ABSTRACT

An aspect of the present invention relates to a method of manufacturing an eyeglass lens, which comprises forming a functional film by coating a coating liquid by spin coating on a lens substrate, wherein the coating liquid is a curable composition comprising a curable component selected from the group consisting of an organic silicon compound and an acrylate compound, and an essential solvent in the form of a ketone or ether solvent with a relative evaporation rate of less than 1.00 when denoting an evaporation rate of butyl acetate as 1.00.

### CROSS-REFERENCE TO RELATED APPLICATIONS

This application claims the benefit of priority under 35 USC 119 to Japanese Patent Application No. 2011-120632 filed on May 30, 2011 and Japanese Patent Application No. 2012-120410 filed on May 28, 2012, which are expressly incorporated herein by reference in their entirety.

### BACKGROUND OF THE INVENTION

1. Field of the Invention

The present invention relates to a method of manufacturing an eyeglass lens, and more particularly, to a method of manufacturing an eyeglass lens having a functional film with good in-plane film thickness uniformity.

2. Discussion of the Background

Eyeglass lenses generally achieve a desired refractive index by means of the lens substrate, and are imparted with various properties (such as photochromic property, antireflective property, and improved durability) by means of functional layers provided on the substrate (for example, Reference 1 (Japanese Unexamined Patent Publication (KOKAI) No. 2010-128422) or English language family members US2010/134753 A1 and U.S. Pat. No. 7,922,325, Reference 2 (Japanese Unexamined Patent Publication (KOKAI) No. 2010-128423) or English language family members US2010/134752A1 and U.S. Pat. No. 8,077,405, and Reference 3 (Japanese Examined Patent Publication (KOKOKU) Showa No. 63-37142), which are expressly incorporated herein by reference in their entirety.

Eyeglass lenses having functional films on a lens substrate present the problem of poor appearance due to generation of interference fringes. As described in References 1 and 2, examples of causes of interference fringes are differences in refractive index between the lens substrate and the functional films, and nonuniformity in the film thickness of the functional films.

Reference 3 proposes adding inorganic oxide particles to the hardcoat layer to bring the refractive index of the hardcoat layer closer to that of the lens substrate and inhibit the generation of interference fringes. However, such inorganic oxide particles are generally expensive. Accordingly, it is desirable to inhibit the generation of interference fringes by reducing nonuniformity in the film thickness of the functional films to avoid increased cost.

### SUMMARY OF THE INVENTION

An aspect of the present invention provides for a method of manufacturing an eyeglass lens having a functional film of good in-plane film thickness uniformity.

The present inventor conducted extensive research in this regard, obtaining the new knowledge set forth below.

Widely employed methods of forming functional films include film-forming methods such as the vapor deposition method and sputtering method, as well as coating methods such as spin coating and dip coating. In coating methods, various materials are added to and admixed with a solvent to prepare a coating liquid. The coating liquid is coated on the surface of the lens substrate or the like, after which the solvent is dried off to form a functional film. When comparing film-forming methods and coating methods, coating methods that do not require large-scale equipment are superior for their general-purpose properties.

Accordingly, the present inventor conducted extensive trial and error to discover a means of increasing the in-plane film thickness uniformity of functional films formed by coating methods. As a result, he discovered that by employing a coating liquid containing a curable component selected from the group consisting of organic silicon compounds and acrylate compounds and containing an essential solvent in the form of a ketone or ether solvent with a relative evaporation rate of less than 1.00 when denoting the evaporation rate of butyl acetate as 1.00 to form a functional film by spin coating, it was possible to increase the in-plane film thickness uniformity of a functional film and thus inhibit the generation of interference fringes. Rapidly evaporating the solvent in the coating liquid during spin coating causes the center portion to become thick due to the loss of fluidity of the film before the coating liquid spreads uniformly in-plane due to the centrifugal force caused by rotation. Conversely, drying the film too slowly causes the liquid to remain in the peripheral portions and the peripheral portions to thicken due to the centrifugal force exerted on the coating liquid that has uniformly spread over the surface. In both cases, the in-plane film thickness uniformity decreases. By contrast, the fact that the drying rate of the coating liquid could be suitably controlled by combining a curable component selected from the group consisting of organic silicon compounds and acrylate compounds and an essential solvent in the form of a ketone or ether solvent with a relative evaporation rate of less than 1.00 when denoting the evaporation rate of butyl acetate as 1.00 was surmised by the present inventor to be why it was possible to form a functional film of uniform film thickness.

The present inventor devised the present invention on the basis of the above knowledge.

An aspect of the present invention relates to a method of manufacturing an eyeglass lens, which comprises:

forming a functional film by coating a coating liquid by spin coating on a lens substrate, wherein

the coating liquid is a curable composition comprising a curable component selected from the group consisting of an organic silicon compound and an acrylate compound, and an essential solvent in the form of a ketone or ether solvent with a relative evaporation rate of less than 1.00 when denoting an evaporation rate of butyl acetate as 1.00.

The boiling point of the essential solvent may be equal to or higher than 115° C. and equal to or lower than 170° C.

The essential solvent may be selected from the group consisting of diacetone alcohol, propylene glycol monomethyl ether acetate, propylene glycol monomethyl ether, and ethylene glycol monoethyl ether acetate.

The polarizing layer comprising a dichroic dye may be formed on the lens substrate and the functional film may be formed directly, or indirectly through another layer, on the polarizing layer.

As the another layer, the primer layer that enhances adhesion between the polarizing layer and the functional film may be formed.

Based on the present invention, a functional film with good in-plane film thickness uniformity can be formed by spin coating. Thus, a high-quality eyeglass lens in which generation of interference fringes is inhibited can be provided.

Other exemplary embodiments and advantages of the present invention may be ascertained by reviewing the present disclosure and the accompanying drawing.

### BRIEF DESCRIPTION OF THE DRAWINGS

The present invention will be described in the following text by the exemplary, non-limiting embodiments shown in the figure, wherein:

FIG. 1 shows the comparison results of Example 1 and Comparative Example 1.

FIG. 2 shows the comparison results of Example 2 and Comparative Example 2.

### DETAILED DESCRIPTION OF THE EMBODIMENTS

Unless otherwise stated, a reference to a compound or component includes the compound or component by itself, as well as in combination with other compounds or components, such as mixtures of compounds.

As used herein, the singular forms “a,” “an,” and “the” include the plural reference unless the context clearly dictates otherwise.

Except where otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not to be considered as an attempt to limit the application of the doctrine of equivalents to the scope of the claims, each numerical parameter should be construed in light of the number of significant digits and ordinary rounding conventions.

Additionally, the recitation of numerical ranges within this specification is considered to be a disclosure of all numerical values and ranges within that range. For example, if a range is from about 1 to about 50, it is deemed to include, for example, 1, 7, 34, 46.1, 23.7, or any other value or range within the range.

The following preferred specific embodiments are, therefore, to be construed as merely illustrative, and non-limiting to the remainder of the disclosure in any way whatsoever. In this regard, no attempt is made to show structural details of the present invention in more detail than is necessary for fundamental understanding of the present invention; the description taken with the drawings making apparent to those skilled in the art how several forms of the present invention may be embodied in practice.

The present invention relates to a method of manufacturing an eyeglass lens, which comprises forming a functional film by coating a coating liquid by spin coating on a lens substrate, wherein the coating liquid is a curable composition comprising a curable component selected from the group consisting of an organic silicon compound and an acrylate compound, and an essential solvent in the form of a ketone or ether solvent with a relative evaporation rate of less than 1.00 when denoting an evaporation rate of butyl acetate as 1.00. By using the above coating liquid in spin coating, it is possible to form a functional film with good in-plane film thickness uniformity. As a result, it is possible to provide a high-quality eyeglass lens in which poor appearance caused by generation of interference fringes are reduced or inhibited.

The method of manufacturing an eyeglass lens of the present invention will be described in greater detail below.

Lens Substrate

In the method of manufacturing an eyeglass lens of the present invention, the surface upon which the coating liquid is coated (the coated surface) can be the lens substrate surface, or can be the surface of a coating layer formed on the lens substrate. The coated surface can be of any shape, such as flat, convex, or concave.

The lens substrate is not specifically limited. Materials that are commonly employed as lens substrates in eyeglass lenses can be employed. Specific examples are plastics and inorganic glasses. The thickness and diameter of the lens substrate are not specifically limited. Normally, the thickness is about 1 to 30 mm, and the diameter is about 50 to 100 mm.

Functional Film

The functional film is formed by spin coating a coating liquid on a lens substrate. The coating liquid for forming the functional film is prepared by adding a curable component selected from the group consisting of organic silicon compounds and acrylate compounds and optionally employed known additives to a solvent. In this context, in the present invention, an essential solvent in the coating liquid is employed in the form of a ketone or ether solvent with a relative evaporation rate of less than 1.00 when denoting the evaporation rate of butyl acetone as 1.00. As will be demonstrated in Examples set forth further below, the reason the spin coating method employing the above coating liquid yields a functional film of uniform film thickness is that by the specific combination of a curable component selected from the group consisting of organic silicon compounds and acrylate compounds and a ketone or ether solvent with a relative evaporation rate of less than 1.00 when denoting the evaporation rate of butyl acetate as 1.00, it is possible to control the drying rate of the coating liquid employed to form the functional film.

The solvent of the coating liquid employed to form the functional film need only contain an essential solvent in the form of a ketone solvent or an ether solvent with a relative evaporation rate of less than 1.00 when denoting the evaporation rate of butyl acetate as 1.00. It can be one of ketone or ether solvents exhibiting the above relative evaporation rate or the combination of two or more of such solvents, or a mixed solvent of the above essential solvent and another solvent that does not satisfy the requirements satisfied by the essential solvent (that is, exhibiting the above-stated relative evaporation rate and being a ketone or ether solvent). In this context, another solvent is not limited to ketones and ethers; alcohol solvents and the like can also be employed.

When employing a mixed solvent, it is desirable for the content of ketone or ether solvent having the relative evaporation rate of less than 1.00 to be equal to or more than 20 weight % from the perspective of controlling the drying rate of the coating liquid. From the perspective of suitably controlling the drying rate of the coating liquid, the relative evaporation rate of the essential solvent when denoting the evaporation rate of butyl acetate as 1.00 is preferably equal to or more than 0.10 but less than 1.00, more preferably equal to or more than 0.10 and equal to or less than 0.80, and still more preferably, equal to or more than 0.10 and equal to or less than 0.75.

From the above perspectives, examples of desirable solvents are: diacetone alcohol (with the above relative evaporation rate of 0.15, also referred to as diacetone alcohol), propylene glycol monomethyl ether (with the above relative evaporation rate of 0.71), propylene glycol monomethyl ether acetate (with the above relative evaporation rate of 0.44), and ethylene glycol monoethyl ether acetate (with the above relative evaporation rate of 0.21). In the present invention, the relative evaporation rate is a value that is measured at a temperature of 25° C., at a relative humidity of 50% RH, and at atmospheric pressure. To further raise the uniformity of the film thickness of the functional film that is formed, the boiling point of the organic solvent that is employed as the essential solvent is desirably equal to or higher than 115° C. and equal to or lower than 170° C., and for ether solvents, preferably equal to or higher than 120° C. and equal to or lower than 156° C.

An embodiment of the curable component that is contained in the coating liquid for forming the functional film is an acrylate compound. In the present invention, the term “acrylate compound” includes methacrylate compounds. Hereinafter, the term “(meth)acrylate” shall include the acrylate and the methacrylate.

The acrylate compound is desirably a compound comprising an acryloyloxy or methacryloyloxy group, preferably a multifunctional acrylate compound comprising at least two acryloyloxy or methacryloyloxy groups within the molecule. Multifunctional acrylate compounds can be used to form high-strength coatings by forming crosslinked structures. Thus, they are suitable as curable components for forming functional films (hardcoats) to enhance the durability of an eyeglass lens.

Specific examples of the acrylate compound are ethyleneglycol diacrylate, diethyleneglycol diacrylate, 1,6-hexanediol diacrylate, neopentylglycol diacrylate, trimethylolpropane triacrylate, trimethylolethane triacrylate, tetramethylolmethane triacrylate, tetramethylolmethane tetraacrylate, pentaglycerol triacrylate, pentaerythritol triacrylate, pentaerythritol tetraacrylate, glycerin triacrylate, dipentaerythritol triacrylate, dipentaerythritol tetraacrylate, dipentaerythritol pentaacrylate, dipentaerythritol hexaacrylate, tris(acryloyloxyethyl)isocyanurate, ethyleneglycol dimethacrylate, diethyleneglycol dimethacrylate, 1,6-hexanediol dimethacrylate, neopentylglycol dimethacrylate, trimethylolpropane trimethacrylate, trimethylolethane trimethacrylate, tetramethylolmethane trimethacrylate, tetramethylolmethane tetramethacrylate, pentaglycerol trimethacrylate, pentaerythritol trimethacrylate, pentaerythritol tetramethacrylate, glycerin trimethacrylate, dipentaerythritol trimethacrylate, dipentaerythritol tetramethacrylate, dipentaerythritol pentamethacrylate, dipentaerythritol hexamethacrylate, tris(methacryloyloxyethyl)isocyanurate, a phosphazene-based acrylate compound or phosphazene-based methacrylate compound in which an acryloyloxy group or methacryloyloxy group has been introduced onto the phosphazene ring of a phosphazene compound; a urethane acrylate compound or urethane methacrylate compound obtained by reacting a polyisocyanate having at least two isocyanate groups in the molecule with a polyol compound having at least one acryloyloxy group or methacryloyloxy group and a hydroxyl group; a polyester acrylate compound or polyester methacrylate compound, obtained by reacting with polyol compound having at least two carboxylic acid halides per molecule as well as at least one acryloyloxy group or methacryloyloxy group and a hydroxyl group; and dimers, trimers, and other oligomers and the like of the above compounds.

These compounds can be employed singly or in combinations of two or more. In addition to the above (meth)acrylates, at least one monofunctional (meth)acrylate selected from the group consisting of hydroxyethyl (meth)acrylate, 2-hydroxyethyl (meth)acrylate, 2-hydroxypropyl (meth)acrylate, hydroxybutyl (meth)acrylate, 2-hydroxy-3-phenoxypropyl (meth)acrylate, and glycidyl (meth)acrylate can be compounded, desirably in a proportion of equal to or less than 10.0 mass % relative to the solid component during curing of the curable composition.

A polymerizable oligomer can be added to the coating liquid for forming a functional film to adjust the hardness of the functional film that is formed. Examples of such oligomers are terminal (meth)acrylate polymethylmethacrylate, terminal styryl poly(meth)acrylate, terminal (meth)acrylate polystyrene, terminal (meth)acrylate polyethyleneglycol, terminal (meth)acrylate acrylonitrile-styrene copolymers, terminal (meth)acrylate styrene-methyl (meth)acrylate copolymers, and other macromonomers. The content thereof is desirably 5.0 to 50.0 mass % relative to the solid component during curing of the curable composition. The curing composition containing a curable component in the form of an acrylate compound can also contain a known photopolymerization initiator. The types and quantities of the photopolymerization initiator are not specifically limited and can be suitably established.

Another embodiment of the curable component contained in the coating liquid for forming the functional film is an organic silicon compound. The organic silicon compound denoted by general formula (I) below, or a hydrolysis product thereof, is an example of an organic silicon compound that is desirable from the perspective of forming a functional film of great hardness that is suitable as a hardcoat.

(R¹)ₐ(R³)_{b}Si(OR²)_{4-(a+b)} (1)

In general formula (I), R¹ denotes an organic group having a glycidoxy group, epoxy group, vinyl group, methacryloxy group, acryloxy group, mercapto group, amino group, phenyl group or the like. R² denotes an alkyl group with 1 to 4 carbon atoms, an acyl group with 1 to 4 carbon atoms, or an aryl group with 6 to 10 carbon atoms. R³ denotes an alkyl group with 1 to 6 carbon atoms or an aryl group with 6 to 10 carbon atoms. Each of a and b denotes 0 or 1.

The alkyl groups with 1 to 4 carbon atoms denoted by R² can be linear or branched alkyl groups. Specific examples are a methyl group, ethyl group, propyl group, and butyl group.

Examples of acyl groups with 1 to 4 carbon atoms denoted by R² are an acetyl group, propionyl group, oleyl group, and benzoyl group.

Examples of aryl groups with 6 to 10 carbon atoms denoted by R² are a phenyl group, xylyl group, and tolyl group.

The alkyl groups with 1 to 6 carbon atoms denoted by R³ can be linear or branched alkyl groups. Specific examples are a methyl group, ethyl group, propyl group, butyl group, pentyl group, and hexyl group.

Examples of aryl groups with 6 to 10 carbon atoms denoted by R³ are a phenyl group, xylyl group, and tolyl group.

Specific examples of the compound denoted by general formula (I) are described in paragraph [0073] of Japanese Unexamined Patent Publication (KOKAI) No. 2007-077327, which is expressly incorporated herein by reference in its entirety.

According to the present invention, the generation of interference fringes can be inhibited by increasing the in-plane film thickness uniformity. Thus, from the perspective of inhibiting the generation of interference fringes, it is not necessary to add inorganic oxide particles to the functional film to adjust the refractive index in the present invention. However, the addition of inorganic oxide particles to the functional film is not excluded in the present invention. That is because inorganic oxide particles also contribute to increasing hardness, particularly when employing an organic silicon compound as the curable component.

Examples of inorganic oxide particles that can be employed in the present invention are metal oxide particles such as tungsten oxide (WO₃), zinc oxide (ZnO), silicon oxide (SiO₂), aluminum oxide (Al₂O₃), titanium oxide (TiO₂), zirconium oxide (ZrO₂), tin oxide (SnO₂), beryllium oxide (BeO), and antimony oxide (Sb₂O₅). One type of metal oxide particle may be employed, or two or more types may be employed in combination. The particle diameter of the metal oxide particles desirably falls within a range of 5 to 30 nm from the perspective of achieving both scratch resistance and optical characteristics. For the same reason, the content of inorganic oxide particles in the coating liquid for forming the functional film is normally suitably about 5 to 80 mass % based on the solid component. The inorganic oxide particles are desirably colloidal particles from the perspective of dispersion in the functional film.

The coating liquid for forming the functional film can be prepared by mixing the components set forth above with optional components such as surfactants (leveling agents), as needed. The quantity of solvent in the coating liquid is normally about 30 to 90 mass % based on the total mass of the coating liquid, but is not specifically limited so long as the coating liquid exhibits viscosity capable of coating.

The coating liquid for forming the functional film in the present invention is coated on the lens substrate by spin coating. The spin coating conditions, such as the rotational speed and duration of rotation, can be established within suitable ranges by taking into account the solid component concentration of the coating liquid and the like. Following coating, a curing process (thermosetting, photocuring, or the like) can be conducted based on the curable group contained in the curable component to form a functional film on the lens substrate. Normally, curing is conducted by heating an organic silicon compound and irradiating an acrylate compound with light. The light that is irradiated in photocuring can be, for example, an e-beam or ultraviolet radiation. The type and irradiation conditions of the light that is irradiated are suitably selected based on the type of curable component employed. The thickness of the functional film that is formed can be set based on the objective. For example, in the case of a hardcoat, it is desirably about 0.5 to 10 μm from the perspective of scratch resistance.

As set forth above, the surface that is coated with the coating liquid can be the surface of the lens substrate or the surface of the coating layer formed on the surface of the lens substrate. Eyeglass lenses having coating layers containing dye tend to develop defects in appearance due to interference fringes. The method of manufacturing an eyeglass lens of the present invention can increase the in-plane film thickness uniformity of the functional film, thereby inhibiting the generation of interference fringes. Thus, it is desirably employed as a method of manufacturing an eyeglass lens containing a dye layer. An example of a dye layer is a polarizing layer containing a dichroic dye. That is, in one embodiment of the present invention, a polarizing layer containing a dichroic dye can be formed on the lens substrate, and the functional film can be formed on the polarizing layer, either directly or through another layer. When forming a functional film on the polarizing layer, it is suitable to form a primer layer to enhance adhesion between the two. The primer layer can be formed of a known resin, such as polyurethane, that functions as an adhesive layer. The thickness of the primer layer is suitably about 0.5 to 10 μm from the perspective of enhancing adhesion.

Normally, the polarizing ability of the polarizing layer is achieved by uniaxially orienting the dichroic dye. To uniaxially orient the dichroic dye in this manner, one common practice is to coat the coating liquid of the polarizing layer on a surface having grooves. The grooves can be formed on the substrate surface, or can be formed on the surface of an orientation layer provided on the lens substrate, which is advantageous for achieving good polarizing performance by the dichroic dye. Before forming the primer layer, it is also desirable to treat the polarizing layer to render it insoluble after drying the coating liquid that has been coated to increase the stability of the film. To increase the film strength and stability, it is desirable to subject the dichroic dye to an immobilizing treatment (form a protective layer to immobilize the dye). The immobilizing treatment is desirably conducted after the insolubilizing treatment. The immobilizing treatment can render the dichroic dye immobile in an oriented state in the polarizing film. Details on polarizing lenses having an orientation layer and a polarizing layer containing a dichroic dye are given in paragraphs [0056] to [0100], and Examples, of Published Japanese Translation (TOKUHYO) No. 2008-527401 of a PCT International Application, which is expressly incorporated herein by reference in its entirety; and paragraphs [0013] to [0024] and [0026] to [0036], and Examples, of Japanese Unexamined Patent Publication (KOKAI) No. 2009-237361, which is expressly incorporated herein by reference in its entirety. The present invention also permits the manufacturing of the eyeglass lenses having an orientation layer and a polarizing layer according to the above descriptions.

In the present invention, a further functional film can be formed over the functional films set forth above. For example, in the case of forming an antireflective film as a functional film, the antireflective film can be a single layer or multiple layers comprised of known inorganic oxides. Examples of these inorganic oxides are silicon dioxide (SiO₂), zirconium oxide (ZrO₂), aluminum oxide (Al₂O₃), niobium oxide (Nb₂O₅), and yttrium oxide (Y₂O₃). The formation method is not specifically limited. The thickness of the antireflective film can be, for example, 0.1 to 5 μm. Layers of functional films in the form of water-repellent films, UV-absorbing films, IR-absorbing films, photochromic films, antistatic films, and the like can also be laminated.

Based on the present invention as set forth above, the film thickness nonuniformity of a functional film formed from a curable component selected from the group consisting of organic silicon compounds and acrylate compounds can be reduced, thereby providing a high-quality eyeglass lens in which the generation of interference fringes is inhibited. To obtain a high-quality eyeglass without defects in appearance due to interference fringes, the variation in in-plane film thickness of the lens effective surface of the functional film (the area of the portion that is present on the eyeglass) is desirably not greater than 10% of the film thickness at the geometric center. That is, for a functional film that is 3 μm in thickness at its geometric center, the thickness of each portion on the lens effective surface desirably falls within a range of 3±0.3 μm. This variation in film thickness is preferably not greater than 5%, more preferably not greater than 2%, of the film thickness at the geometric center.

### EXAMPLES

The present invention will be further described based on Examples. However, the present invention is not limited to the embodiments shown in Examples.

### Example 1

### Fabricating a Polarizing Lens

### (1) Forming an Orientation Layer

A polyurethane urea lens (product name Phoenix, made by Hoya Corp, refractive index 1.53, with hardcoat, 70 mm in diameter, base curve 4, center thickness 1.5 mm) was employed. A SiO₂ film 0.2 μm in thickness was formed by vacuum vapor deposition on the concave surface of the lens.

Abrasive-containing urethane foam (abrasive: product name Polipla203A, made by Fujimi Inc., Al₂O₃ particles with average particle diameter of 0.8 μm, urethane foam roughly identical in curvature to the concave surface of the lens) was employed to subject the SiO₂ film that had been formed to 30 seconds of uniaxial polishing under conditions of 350 rpm and a polishing pressure of 50 g/cm². The polished lens was washed in pure water and dried.

### (2) Forming a Polarizing Film

After drying the lens, 2 to 3 g of an aqueous solution of about 5 mass % water-soluble dichroic dye (product name Varilight Solution 2S, made by Sterling Optics, Inc.) was spin coated onto the polished surface to form a polarizing film. The spin coating was conducted by feeding the aqueous dye solution at a rotational speed of 300 rpm, maintaining that rotational speed for 8 seconds, maintaining a rotational speed of 400 rpm for 45 seconds, and then maintaining a rotational speed of 1,000 rpm for 12 seconds.

Next, a pH 3.5 aqueous solution with an iron chloride concentration of 0.15 M and a calcium hydroxide concentration of 0.2 M was prepared. The lens that had been obtained in the above was immersed for about 30 seconds in the aqueous solution and then withdrawn and thoroughly washed with pure water. This step rendered the water-soluble dye sparingly soluble (insolubilizing treatment).

### (3) Immobilization Treatment

Following (2) above, the lens was immersed for 15 minutes in a 10 mass % aqueous solution of γ-aminopropyltriethoxysilane. It was subsequently washed three times with pure water, heat treated for 30 minutes in a heating furnace (internal temperature of furnace: 85° C.), removed from the furnace, and cooled to room temperature.

Following cooling, the lens was immersed for 30 minutes in a 2 mass % aqueous solution of γ-glycidoxypropyltrimethoxysilane. Following the immobilization treatment, the lens was heat treated for 30 minutes in a heating furnace (internal temperature of furnace: 60° C.), removed from the furnace, and cooled to room temperature.

Following the above treatment, the thickness of the polarizing film fowled was about 1 μm.

### (4) Forming a Primer Layer

A water-based polyurethane resin composition was spin coated on the surface of the polarizing film following the above cooling. The spin coating was conducted by feeding the composition onto the polarizing film at a rotational speed of 100 rpm, maintaining that speed for 10 seconds, maintaining a rotational speed of 400 rpm for 10 seconds, and then maintaining 1,000 rpm for 30 seconds.

Following the spin coating, the lens was subjected to dry treatment for 30 minutes in a heating furnace (internal temperature of furnace: 60° C.) to remove the water, thereby forming a primer layer on the polarizing film. The thickness of the primer layer formed as 0.30 μm.

### (5) Forming an Acrylic Hardcoat

A coating liquid obtained by mixing 1,000 mass parts of dipentaerythritol hexacrylate (Kayarad DPHA, made by Nippon Kayaku Co., Ltd.), 3,000 mass parts of diacetone alcohol, and 30 mass parts of photopolymerization initiator (Irgacure 819, made by Ciba Japan) was spin coated onto the lens that had been treated in (4) above. Following coating, the coating was cured at a UV irradiation level of 1,200 mJ/cm² with an UV radiation device to obtain an acrylic hardcoat.

### Comparative Example 1

With the exception that 3,000 mass parts of a mixed solvent with a 3:1 ratio (mass ratio) of isopropyl alcohol and 1-butanol was employed as the solvent in the coating liquid for forming an acrylic hardcoat, a polarizing lens was fabricated by the same method as in Example 1.

### Example 2

With the exception that the hardcoat was formed by the following method, a polarizing lens was fabricated by the same method as in Example 1.

To a glass vessel equipped with magnetic stirrer were charged 17 mass parts of γ-glycidoxypropyltrimethoxysilane, 30 mass parts of diacetone alcohol, and 28 mass parts of water-dispersed colloidal silica (solid component 40 mass %, average particle diameter 15 nm). The mixture was thoroughly mixed and then stirred for 24 hours at 5° C. Next, 15 mass parts of diacetone alcohol, 0.05 mass part of silicone surfactant, and 1.5 mass parts of a curing agent in the form of aluminum acetylacetonate were added. The mixture was thoroughly stirred and filtered to prepare a hardcoat coating liquid (hardcoat composition). The pH of the coating liquid was about 5.5

After spin coating (1,000 rpm maintained for 30 seconds) the hardcoat coating composition that had been thus prepared on the surface of the primer of the lens that had been subjected to the treatment of (4) above, thermosetting was conducted for 60 minutes at 100° C. to form a hardcoat.

### Comparative Example 2

With the exception that a mixed solvent in the form of a 3:1 ratio (mass ratio) of isopropyl alcohol and 1-butanol was employed instead of diacetone alcohol in Example 2, a polarizing lens was fabricated by the same method as in Example 2.

Evaluation Methods

(1) Evaluation of in-Plane Film Thickness Uniformity

The thicknesses of the hardcoats of the polarizing lenses fabricated in Examples 1 and 2 and Comparative Examples 1 and 2 were measured with an optical interference film thickness meter at a total of 13 points consisting of the geometric center of the lens and 12 points on an imaginary line running through the geometric center.

### (2) Presence or Absence of Interference Fringes

The polarizing lenses fabricated in Examples 1 and 2 and Comparative Examples 1 and 2 were placed in a dark location, irradiated with high-intensity light, and photographed with a digital camera.

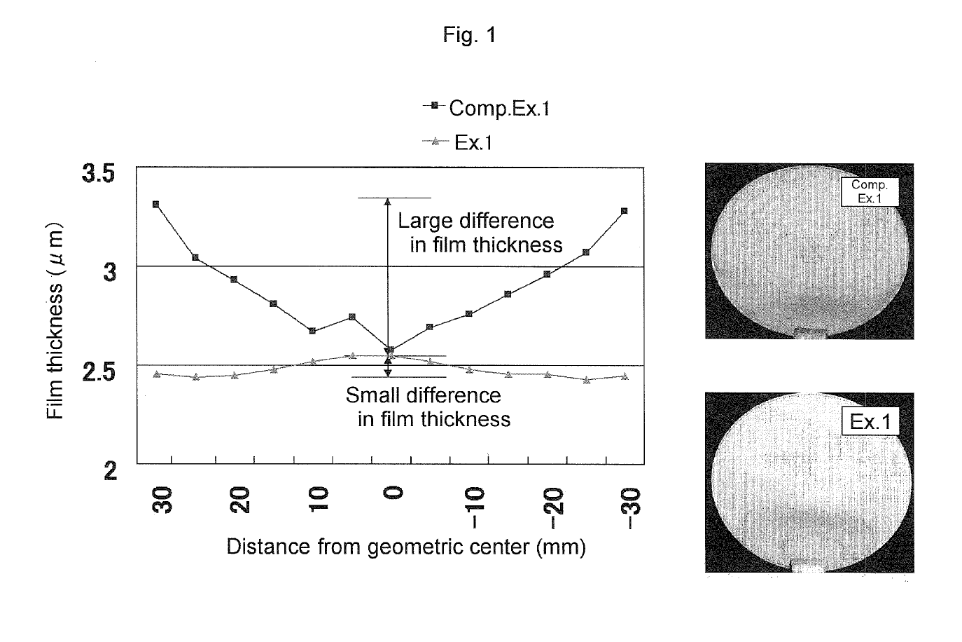

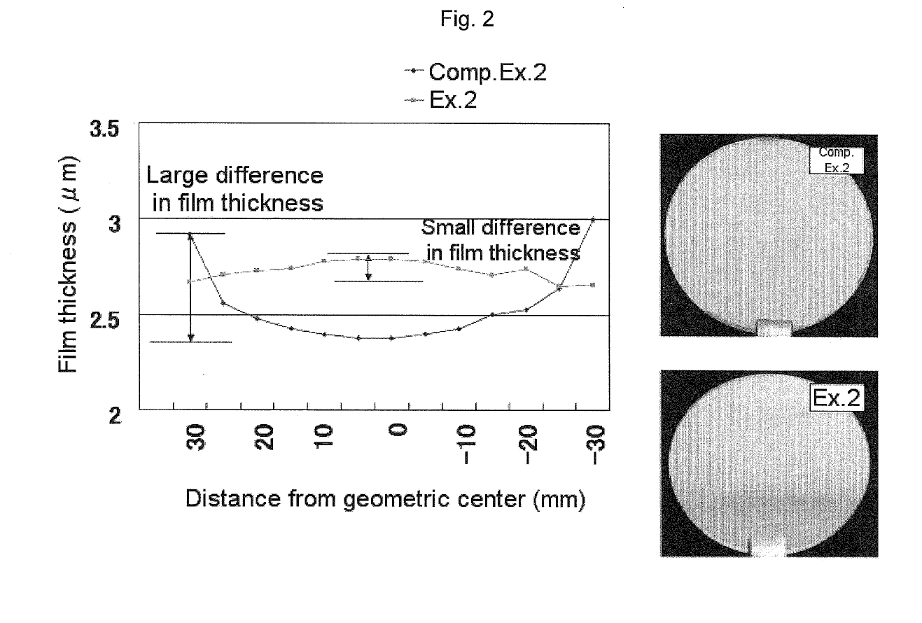

The results of the above are given in FIGS. 1 and 2.

As shown in FIG. 1, Example 1, in which a hardcoat was formed using a coating liquid containing an acrylate compound and diacetone alcohol, exhibited less film thickness variation in the hardcoat, permitting the formation of a hardcoat of more uniform film thickness, than in Comparative Example 1, in which a mixed solvent of isopropyl alcohol and 1-butanol was employed instead of diacetone alcohol.

In addition, as shown in FIG. 2, Example 2, in which a hardcoat was formed using a coating liquid containing an organic silicon compound and diacetone alcohol, exhibited less film thickness variation in the hardcoat, permitting the formation of a hardcoat of more uniform film thickness in than Comparative Example 2, in which a mixed solvent of isopropyl alcohol and 1-butanol was employed instead of diacetone alcohol.

As shown in FIGS. 1 and 2, in contrast to Comparative Examples 1 and 2, in which the variation in in-plane film thickness of the hardcoat was considerable and in which interference fringes were found, the eyeglass lenses of Examples 1 and 2 exhibited good external appearances without interference fringes. Thus, it was confirmed that the generation of interference fringes could be inhibited by enhancing the in-plane film thickness uniformity of the hardcoat.

Since the film was thick in peripheral portions in Comparative Examples 1 and 2, the fact that drying of the coating liquid for forming the hardcoat had been slow and the liquid had built up, and the fact that this had caused the nonuniformity in the film thickness, were confirmed.

By contrast, the rates of evaporation of the organic solvents employed in Comparative Examples 1 and 2 were greater than that of the diacetone alcohol employed in Examples 1 and 2 (see Table 1 below). Looking just at the evaporation rate of the organic solvent, the drying rates of the coating liquids employed in Comparative Examples 1 and 2 were more rapid than those of the coating liquids employed in Examples 1 and 2. Accordingly, it was anticipated that the phenomenon of thickening at the center would be greater than the buildup of liquid in peripheral portions. However, contrary to expectation, the opposite result was achieved. Thus, not only did the rate of evaporation of the organic solvent have an influence, but the combination of diacetone alcohol and a curable component selected from the group consisting of organic silicon compounds and acrylate compounds was also found to specifically have an effect in reducing film thickness nonuniformity.

TABLE 1

| | Relative evaporation rate |
|---|---|
| Diacetone alcohol | 0.15 |
| Isopropyl alcohol | 1.50 |
| 1-butanol | 0.47 |

### Example 3

With the exception that a mixed solvent consisting of a 6:4 ratio (mass ratio) of diacetone alcohol and propylene glycol monomethyl ether (relative evaporation rate: 0.71) was employed instead of diacetone alcohol, a polarizing lens was obtained by the same method as in Example 1.

### Example 4

With the exception that a mixed solvent of a 6:4 ratio (mass ratio) of diacetone alcohol and propylene glycol monomethyl ether (relative evaporation rate: 0.71) was employed instead of diacetone alcohol, a polarizing lens was obtained by the same method as in Example 2.

### Example 5

With the exception that 3,000 mass parts of a mixed solvent of a 3:1 ratio (mass ratio) of isopropyl alcohol and propylene glycol monomethyl ether acetate (relative evaporation rate: 0.44) was employed instead of 3,000 mass parts of a mixed solvent of a 3:1 ratio (mass ratio) of isopropyl alcohol and 1-butanol as the solvent in the coating liquid for forming the acrylic hardcoat, a polarizing lens was fabricated by the same method as in Comparative Example 1.

### Example 6

With the exception that a mixed solvent of a 3:1 ratio (mass ratio) of isopropyl alcohol and propylene glycol monomethyl ether acetate (relative evaporation rate: 0.44) was employed instead of a mixed solvent of a 3:1 ratio (mass ratio) of isopropyl alcohol and 1-butanol, a polarizing lens was fabricated by the same method as in Comparative Example 2.

### Example 7

With the exception that 3,000 mass parts of a mixed solvent of a 3:1 ratio (mass ratio) of isopropyl alcohol and diacetone alcohol was employed instead of 3,000 mass parts of a mixed solvent of a 3:1 ratio (mass ratio) of isopropyl alcohol and 1-butanol as the solvent in the coating liquid for forming the acrylic hardcoat, a polarizing lens was fabricated by the same method as in Comparative Example 1.

### Example 8

With the exception that a mixed solvent of a 3:1 ratio (mass ratio) of isopropyl alcohol and diacetone alcohol was employed instead of a mixed solvent of a 3:1 ratio (mass ratio) of isopropyl alcohol and 1-butanol, a polarizing lens was fabricated by the same method as in Comparative Example 2.

Evaluation of the in-plane film thickness uniformity of the polarizing lenses prepared in Examples 3 to 8 in the same manner as in the above Examples revealed slightly greater variation in film thickness than in Examples 1 and 2, but still much less than in Comparative Examples 1 and 2. The variation was within 5% of the film thickness at the geographic center.

The propylene glycol monomethyl ether acetate employed in Examples 5 and 6 (relative evaporation rate: 0.44) exhibited a similar rate of evaporation to the 1-butanol (relative evaporation rate: 0.47) employed in Comparative Examples 1 and 2. However, as set forth above, there were great differences in film thickness uniformity. These results show that an effect of decreasing film thickness nonuniformity was not achieved even at a relative evaporation rate of less than 1.00 with an alcohol solvent, and that by using propylene glycol monomethyl ether acetate, which is an ether solvent with a relative evaporation rate of less than 1.00 in combination with a curable component selected from the group consisting of organic silicon compounds and acrylate compounds, a good film thickness nonuniformity reducing effect was specifically achieved.

### Example 9

With the exception that ethylene glycol monoethyl ether acetate (relative evaporation rate: 0.21) was employed instead of diacetone alcohol, a polarizing lens was obtained by the same method as in Example 2. A hardcoat of uniform film thickness could be formed.

The boiling points of the solvents employed in the Examples are given in Table 2.

TABLE 2

| | Boiling point |
|---|---|
| Diacetone alcohol | 168° C. |
| Propylene glycol monomethyl ether | 120° C. |
| Propylene glycol monomethyl ether acetate | 146° C. |
| Ethylene glycol monoethyl ether acetate | 156° C. |

In the Examples set forth above, the hardcoat was formed at room temperature, under atmospheric pressure, and without controlling the humidity. However, heating or cooling the atmosphere in which the hardcoat is formed, increasing or decreasing the humidity, and increasing or decreasing the pressure can be combined in any combination to form the hardcoat.

The present invention is useful in the field of manufacturing eyeglass lenses.

Although the present invention has been described in considerable detail with regard to certain versions thereof, other versions are possible, and alterations, permutations and equivalents of the version shown will become apparent to those skilled in the art upon a reading of the specification and study of the drawings. Also, the various features of the versions herein can be combined in various ways to provide additional versions of the present invention. Furthermore, certain terminology has been used for the purposes of descriptive clarity, and not to limit the present invention. Therefore, any appended claims should not be limited to the description of the preferred versions contained herein and should include all such alterations, permutations, and equivalents as fall within the true spirit and scope of the present invention.

Having now fully described this invention, it will be understood to those of ordinary skill in the art that the methods of the present invention can be carried out with a wide and equivalent range of conditions, formulations, and other parameters without departing from the scope of the invention or any Examples thereof.

All patents and publications cited herein are hereby fully incorporated by reference in their entirety. The citation of any publication is for its disclosure prior to the filing date and should not be construed as an admission that such publication is prior art or that the present invention is not entitled to antedate such publication by virtue of prior invention.

What is claimed is:

1. A method of manufacturing an eyeglass lens, which comprises:
forming a functional film by coating a coating liquid by spin coating on a lens substrate, wherein
the coating liquid is a curable composition comprising a curable component selected from the group consisting of an organic silicon compound and an acrylate compound, and an essential solvent in the form of a ketone or ether solvent with a relative evaporation rate of less than 1.00 when denoting an evaporation rate of butyl acetate as 1.00.

2. The method of manufacturing an eyeglass lens according to claim 1, wherein a boiling point of the essential solvent is equal to or higher than 115° C. and equal to or lower than 170° C.

3. The method of manufacturing an eyeglass lens according to claim 1, wherein the essential solvent is selected from the group consisting of diacetone alcohol, propylene glycol monomethyl ether acetate, propylene glycol monomethyl ether, and ethylene glycol monoethyl ether acetate.

4. The method of manufacturing an eyeglass lens according to claim 1, wherein a polarizing layer comprising a dichroic dye is formed on the lens substrate and the functional film is formed directly, or indirectly through another layer, on the polarizing layer.

5. The method of manufacturing an eyeglass lens according to claim 4, which comprises forming, as the another layer, a primer layer that enhances adhesion between the polarizing layer and the functional film.
